(19) United States
(12) Patent Application Publication
(10) Pub. No.: US 2007/0028743 A1
(43) Pub. Date: Feb. 8, 2007

(54) Device for punching packaging elements or the like

(76) Inventor: Joachim Jakob, Radolfzell (DE)

Correspondence Address: BACHMAN & LAPOINTE, P.C., 900 CHAPEL STREET, SUITE 1201, NEW HAVEN, CT, 06510, US

(21) Appl. No.: 10/572,020

(22) PCT Filed: Nov. 12, 2003
(86) PCT No.: PCT/EP03/12640

§ 371 Date: Mar. 13, 2006

(30) Foreign Application Priority Data
Sep. 4, 2003 (DE) 203 13 904.6

(51) Int. Cl. B26F 1/14; B26D 1/00

(52) U.S. Cl. 83/686; 83/695

(57) ABSTRACT

A device for punching flat packaging elements or the like such as sheets of paper, cardboard or corrugated board, comprising punching blades, which project from a punching die while serving as a shaping or cutting element. The sheet placed on a supporting punching plate is assigned to the blade tips or cutting edges of the punching blades, and a layer made of a magnetic material is placed between the surface of the supporting punching plate and the sheet to be punched. The layer is made of an elastic magnetic material, optionally from a magnetized plastic. It can be provided in the form of a thin mat, which is made of magnetic material and which spans the contact surface for the sheets to be punched.

### BACKGROUND OF THE INVENTION

The invention relates to a device for punching flat packaging elements or the like—such as sheets of paper, cardboard or corrugated board—comprising punching blades, which project from a punching die while serving as a shaping or cutting element; the sheet placed on a supporting punching plate is assigned to the punching blades on a supporting punching plate.

Such punching devices are known in particular for producing blanks from cardboard sheets in the folding box industry; by virtue of the punching operation, contours are formed in the cardboard sheet which is then passed to a downstream cutting-out device. Cutting-out stations of this type can be found in EP 0 446 702 A2.

A considerable disadvantage of known punching machines is that the tips or cutting edges of the punching blades cannot be adapted to the same penetration depth, and this is undesirable; in a sectional image, these cutting edges would generate points of a curve since they are at different spacings from the support of the sheet to be processed.

Knowing these conditions, the inventor set himself the aim of eliminating these shortcomings and providing compensation of the blade heights in punching devices and thus providing an improvement to the punching process.

### SUMMARY OF THE INVENTION

The teaching of the present invention aims to achieve this object; the present invention provide advantageous further developments. Moreover, all combinations of at least two of the features disclosed in the description and the drawing fall within the scope of the invention. In the case of stated size ranges, values lying within the stated limits are also intended to be disclosed as limit values and can be used at will.

According to the invention, a layer made of a magnetic material, in particular of an elastic magnetic material, is placed between the surface of the supporting punching plate and the sheet to be punched. Said material is preferably a magnetic plastic.

It has proven to be advantageous to provide a mat of magnetic material as the layer; this can be replaced. In one application according to the invention, it spans the contact surface for the sheets to be punched, but may also be composed of mat elements in the manner of a mosaic, preferably of mat elements having a size of approximately 250 mm×250 mm. In this connection—although not being restricted thereto—it is pointed out that the layer or mat may contain zones having a different magnetic force—from very weak to very strong—distributed over the entire surface.

In the described embodiments, the layer or mat compensates the different punching pressure of the punching blades and thus equalizes the cutting quality of all blades substantially to one level. The concept according to the invention leads to a considerable improvement in the punching process in the case of flat bed punching machines and flat bed punching units (e.g. inline punching); this compensation mat is made of magnetic material with reciprocal action.

It is also within the scope of the invention that a metallic counter-punching plate is placed between the sheet to be punched and the layer or mat of magnetic material; the thickness of said counter-punching plate should preferably correspond to the thickness of the layer or mat. According to a further feature of the invention, the counter-punching plate—and thus also the thickness of the mat—is approximately 1 mm.

The invention achieves
blade compensation of the punching blades, that is to say manual alignment is considerably reduced;
flat adhesion of the punching plate to a counter-punching plate

By virtue of the invention, the blade tips or cutting edges of the punching blades define a straight line which runs parallel to the surface of the supporting punching plate, instead of lying on a curved curve as in the prior art.

A reduction in wear on the blades and a uniform cutting quality lead to a noticeable improvement in quality.

A reduction in set-up time is achieved by means of much less manual alignment/gluing and alternate use of a punching die in different punching machines.

A multisheet capability is also achieved; on account of less subsequent gluing, there are fewer stoppage times during production and, on account of uniform, flat adhesion of the punching plate, there are less hollow spaces which would possibly yield uncontrollably during punching.

Finally, the invention leads to a reduction in costs for punching dies by virtue of an extended service life of the blades, and also omits the need for expensive special blades by using standard blades.

### BRIEF DESCRIPTION OF THE DRAWINGS

Further advantages, features and details of the invention emerge from the following description of preferred examples of embodiments and with reference to the drawing, in which:

FIGS. 1, 3 in each case show a cross section through part of a punching system;

FIGS. 2, 4 in each case show an enlarged detail from FIG. 1 and FIG. 3, respectively.

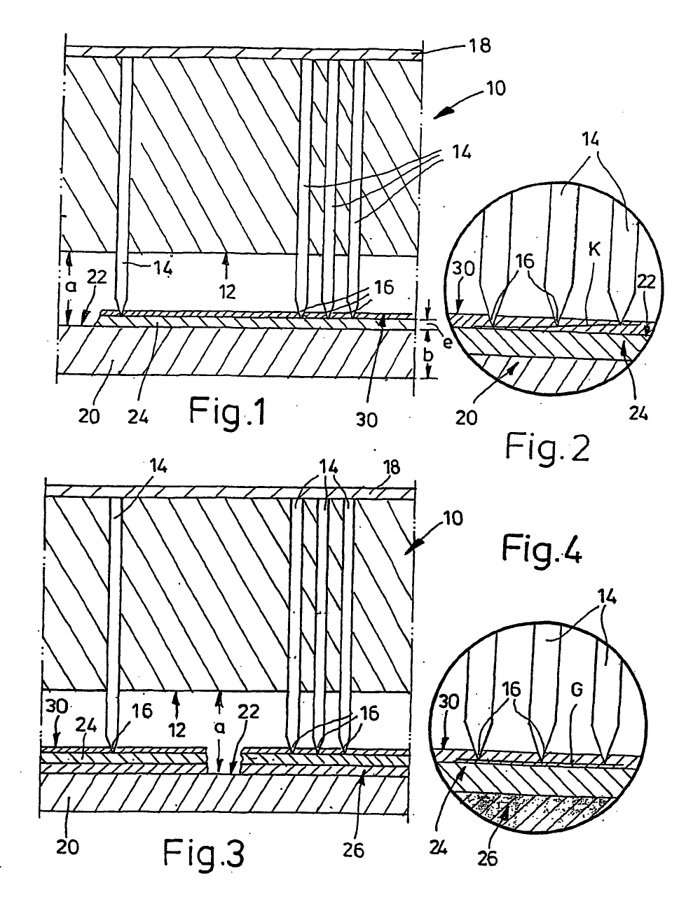

### DETAILED DESCRIPTION

A punching die 10 contains a number of punching blades 14 which project from its lower face 12 at one end and have blade tips or cutting edges 16 at the end. The punching blades 14 pass through the punching die more or less vertically and are covered over in the top region of the punching die 10 by an alignment plate 18.

Assigned in a parallel manner to the lower face 12 of the punching die 10 at a distance a therefrom is a supporting punching plate 20 having a thickness b of in this case approximately 4 mm; a sheet 30 to be punched, made of paper, cardboard or other such material, rests on said supporting punching plate 20, optionally with the interposition of a counter-punching place 24, and said sheet is processed by the cutting edges 16.

The counter-punching plate 24 is formed by a soft or hard plate—depending on the process—having a thickness e of for example 1 mm. For example, a relatively soft plate allows penetration of the punching blades 14.

As can clearly be seen from the enlarged detail of FIG. 2, in the punching die 10 there are usually slightly different spacings—in the manner of a curve K—of the cutting edges 16 from the surface 22 of the supporting punching plate 20, which leads to imprecise indentations in the sheet 30 to be punched.

This drawback is overcome by the system of FIGS. 3, 4, as can clearly be seen from the straight line G in FIG. 4; said straight line runs parallel to the surface 22 of the supporting punching plate 20. A magnetic compensation mat 26 having a thickness i of for example 1 mm lies on the supporting punching plate 20 here. This compensation mat 26, which balances out the pressure, covers the entire punching surface between counter-punching plate 24 and supporting plate 20 in a manner depending on the format, that is to say either as a tailored mat or in the manner of a mosaic composed of equal-sized squares of for example 250 mm×250 mm×1 mm.

Not shown in the drawing is the fact that the magnetic compensation mat 26 may be divided into zones of different field strength or magnetic force—from very weak to very strong. This can be implemented for example by means of mat elements, of which the compensation mat is then composed.

1. A device for punching flat packaging elements or the like such as sheets (30) of paper, cardboard or corrugated board, comprising punching blades (14), which project from a punching die (10) while serving as a shaping or cutting element, wherein the sheet (20) placed on a supporting punching plate (20) is assigned to the blade tips or cutting edges (16) of the punching blades (14), characterized in that a layer (26) made of a magnetic material is placed between the surface (22) of the supporting punching plate (20) and the sheet (30) to be punched.

2. The device as claimed in claim 1, characterized in that the layer (26) is made of an elastic magnetic material.

3. The device as claimed in claim 1, characterized in that the layer (26) is made of a magnetized plastic.

4. The device as claimed in claim 1, characterized in that a thin mat (26) of magnetic material is provided as the layer.

5. The device as claimed in claim 4, characterized in that the mat (26) spans the contact surface (22) for the sheets (30) to be punched.

6. The device as claimed in any of claims 1 to 4, characterized in that the layer (26) is composed of mat elements in the manner of a mosaic.

7. The device as claimed in claim 4, characterized by mat elements having a size of approximately 250×250 mm.

8. The device as claimed in claim 1, characterized in that the surface of the magnetic layer or mat (26) is composed of zones having a different strength of magnetic force.

9. The device as claimed in claim 1, characterized in that a metallic counter-punching plate (24) is placed between the sheet (30) to be punched and the layer or mat (26) of magnetic material.

10. The device as claimed in 9 claim 9, characterized in that the thickness (i) of the layer or mat (26) corresponds approximately to the thickness (a) of the counter-punching plate (24).

11. The device as claimed in claim 10, characterized by a thickness (e) of the counter-punching plate (24) of approximately 1 mm.

12. The device as claimed in claim 1, characterized in that the blade tips or cutting edges (16) of the punching blades (14) define a straight line (G) which runs parallel to the surface (22) of the supporting punching plate (20).
